(19) United States
(12) Patent Application Publication
(10) Pub. No.: US 2006/0087768 A1
(43) Pub. Date: Apr. 27, 2006

(54) Method and apparatus for electrically coupling a slider to a wireless suspension substrate

(76) Inventors: A. David Erpelding, San Jose, CA (US); Victor Wing Chum Shum, San Jose, CA (US)

Correspondence Address: WAGNER, MURABITO & HAO LLP, Third Floor, Two North Market Street, San Jose, CA, 95113, US

(21) Appl. No.: 10/974,485

(22) Filed: Oct. 26, 2004

(51) Int. Cl. G11B 5/60

(52) U.S. Cl. 360/234.5

(57) ABSTRACT

A method and apparatus for electrically coupling a slider to a wireless suspension is disclosed. The wireless suspension includes a substrate material and at least one standoff coupled to the substrate material. The at least one standoff is configured to be coupled to a slider and is further configured to electrically couple the slider to the substrate material.

### TECHNICAL FIELD

Embodiments of the present invention relate to the field of hard disk drives, and more particularly to an apparatus and method for electrically coupling a slider to a wireless suspension substrate.

### BACKGROUND ART

A wireless suspension used in a Data Access Storage Device (DASD), such as, for example, a hard disk drive (HDD), uses an adhesive bond for attaching the slider to the area of the suspension known as the tongue. The slider needs to be elevated above the tongue in order to produce an adhesive bond line of a controlled thickness. The controlled bond line thickness is necessary for controlling stresses that may be transferred to the slider's air bearing surface (ABS) due to different thermal expansion rates of the tongue, the slider and the adhesive during the bonding process and during operation.

The slider needs to remain at a defined height, which is becoming increasingly smaller as more disks are being added to a given drive envelope, and as drive envelopes are shrinking to accommodate smaller and smaller devices. Another requirement is for solder termination pads on the slider to align with solder balls on the wireless suspension so as to form a connection when the solder is reflowed.

Current practice produces a “standoff” from an existing polyimide insulator in the laminate substrate of the wireless suspension (e.g., integrated lead suspension (ILS) or circuit integrated suspension (CIS)) to elevate the slider above the tongue. Because the slider may build up a static charge from its flying action and the sheering air, and the static charge can be damaging to the recording element, an electrically conductive path is needed to dissipate the static charge into the housing of the HDD. Currently this path between the slider and the tongue is provided by the use of electrically conductive adhesives. The present day electrically conductive adhesives require a bond line thickness of 10 μm. This has resulted in a need to reduce the polyimide insulator layer from a thickness of 18 μm to that of 10 μm. This thinned polyimide insulator can be detrimental to data rates because it places the data transmission lines closer to the poorly conductive steel layer. Eddy currents from the transmission lines can induce a current in the steel layer that couples the transmission lines to the steel and increases the impedance in the transmission lines. To compensate for this coupling and added impedance, the transmission lines need to be etched narrower to reduce their capacitance to the steel layer. This requires tighter etching/plating tolerances from the wireless suspension fabricators. In addition, the electrically conductive adhesives require extra time and steps for curing.

One consideration in the conventional art is to use an ultraviolet adhesive which requires a bond line thickness of 5 μm, but is not electrically conductive, and then applying a secondary conductive adhesive. This, however, requires yet another step in the assembly process. In today's ever increasing targets for higher data rate, the approach of creating a controlled slider bond line with standoffs made from the polyimide insulator puts an added restriction on data rate and on wireless suspension manufacturing yields and cost.

### SUMMARY

A method and apparatus for electrically coupling a slider to a wireless suspension is disclosed. The wireless suspension includes a substrate material and at least one standoff coupled to the substrate material. The at least one standoff is configured to be coupled to a slider and is further configured to electrically couple the slider to the substrate material.

### BRIEF DESCRIPTION OF THE DRAWINGS

FIG. 1 is a schematic top plan view of a hard disk drive, in accordance with one embodiment of the present invention.

FIG. 2 is a top plan view of a portion of a wireless suspension and a slider, illustrating a configuration for standoffs, according to one embodiment of the present invention.

FIG. 3 is a cross-sectional view of a slider and standoffs, in accordance with one embodiment of the present invention.

FIG. 4 is a cross-sectional view of a slider and standoffs, in accordance with another embodiment of the present invention.

FIG. 5 is a cross-sectional view of a slider and standoffs, in accordance with another embodiment of the present invention.

FIG. 6 is a flow diagram of a method for electrically coupling a slider to a substrate, in accordance with one embodiment of the present invention.

### DETAILED DESCRIPTION

Reference will now be made in detail to embodiments of the invention, examples of which are illustrated in the accompanying drawings. While the invention will be described in conjunction with the embodiments, it will be understood that they are not intended to limit the invention to these embodiments. Furthermore, in the following detailed description, numerous specific details are set forth in order to provide a thorough understanding of the present invention. In other instances, well known methods, procedures, and components have not been described in detail so as not to unnecessarily obscure aspects of the present invention.

Embodiments of the present invention include an apparatus and method for electrically coupling a slider to a wireless suspension substrate. Embodiments of the present invention provide an electrical coupling between the slider and the wireless suspension substrate so that electrical charges that can build up on the slider can dissipate into the housing of the HDD. This is achieved, in one embodiment, by partially etching existing metals in the wireless suspension substrate to form standoffs that are electrically conductive and that allow a uniform adhesive bond to be formed between the tongue portion of the substrate and the slider. In another embodiment, this is accomplished by creating a via to base metal in the substrate, and plating copper or other conductive metals in the via to form the standoffs.

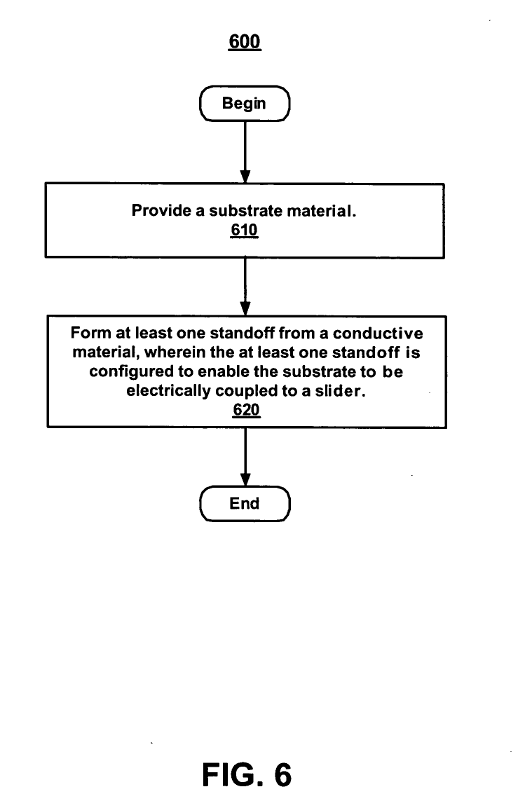

Certain portions of the detailed descriptions of embodiments of the invention, which follow, are presented in terms of processes and methods (e.g., method 600 of FIG. 6). Although specific steps are disclosed herein describing the operations of these processes and methods, such steps are exemplary. That is, embodiments of the present invention are well suited to performing various other steps or variations of the steps recited in the processes and methods herein.

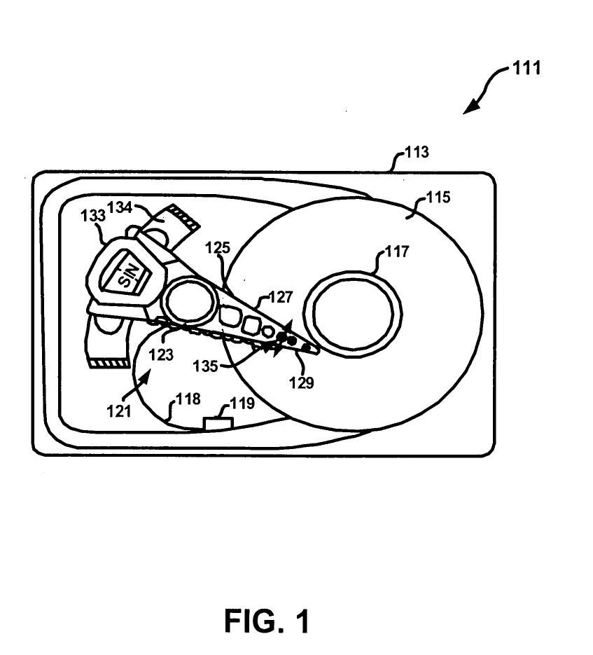

FIG. 1 is a schematic drawing of one embodiment of an information storage system comprising a magnetic hard disk file or drive 111 for a computer system. Drive 111 has an outer housing or base 113 containing a disk pack having at least one media or magnetic disk 115. The disk or disks 115 are rotated by a spindle motor assembly having a central drive hub 117. An actuator 121 comprises a plurality of parallel actuator arms 125 (one shown) in the form of a comb that is movably or pivotally mounted to base 113 about a pivot assembly 123. A controller 119 is also mounted to base 113 for selectively moving the comb of arms 125 relative to disk 115. Control signals are transmitted from controller 119 to actuator 121 through flex cable 118.

In the embodiment shown, each arm 125 has extending from it at least one cantilevered load beam and wireless suspension 127. A magnetic read/write transducer or head is mounted on a slider 129 and secured to a flexure that is flexibly mounted to each suspension 127. The read/write heads magnetically read data from and/or magnetically write data to disk 115. The level of integration called the head gimbal assembly (HGA) is head and slider 129, which are mounted on suspension 127. The slider 129 is usually bonded to the end of wireless suspension 127. The head is typically pico size (approximately 1250×1000×300 microns) and formed from alumina titanium carbide ceramic. The head also may be of “femto” size (approximately 850×700×230 microns) and is pre-loaded against the surface of disk 115 (in the range 0.5 to 3 grams) by suspension 127.

Wireless suspensions 127 have a spring-like quality, which biases or urges the air-bearing surface of the slider 129 against the disk 115 to cause the slider 129 to fly at a precise distance from the disk. A voice coil 133 free to move within a conventional voice coil motor magnet assembly 134 (top pole not shown) is also mounted to arms 125 opposite the HGA. Movement of the actuator 121 (indicated by arrow 135) by controller 119 moves the HGAs along radial arcs across tracks on the disk 115 until the heads settle on their respective target tracks. The HGAs operate in a conventional manner and always move in unison with one another, unless drive 111 uses multiple independent actuators (not shown) wherein the heads can move independently of one another.

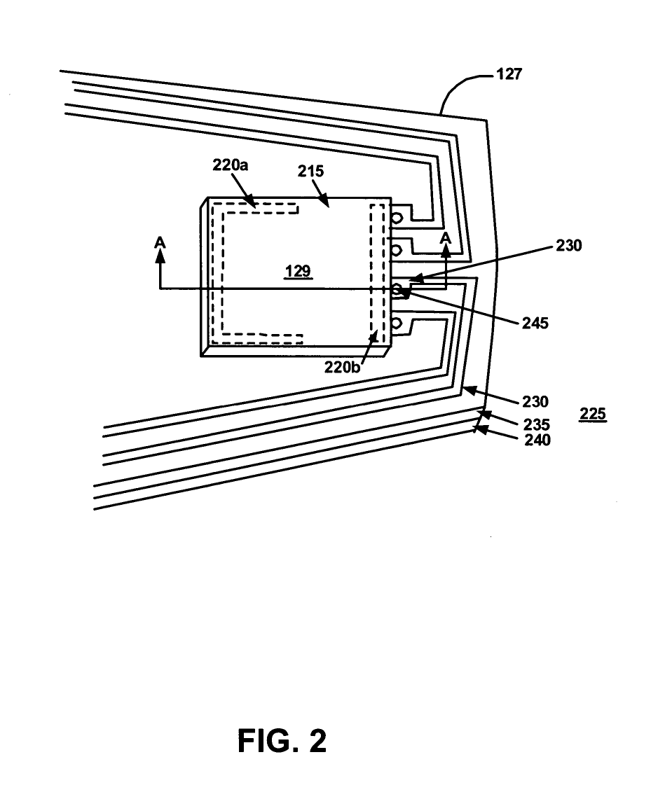

FIG. 2 is a plan view of a portion of a wireless suspension 127 with a slider 129, illustrating a configuration for standoffs 220a and 220b, according to one embodiment of the present invention. Wireless suspension apparatus 127 is formed from a substrate 225. Substrate 225 is, in one embodiment, a laminate of at least three layers, 230, 235 and 240, of materials. Layer 230 may be a highly conductive metal, e.g., copper or copper alloy, from which the transmission lines may be formed. Layer 235 can be an insulating layer, separating layer 230 from layer 240, where layer 240 may be a base metal, such as stainless steel. In another embodiment, layer 240 may be another layer of copper or copper alloy. In another embodiment, substrate 225 may begin as a single layer upon which additional layers become deposited.

According to one embodiment, solder balls 245 on the transmission lines formed from copper layer 230 of substrate 225 align with termination pads on slider 129 to form electrical connections for signal transmissions between slider 129 and wireless suspension apparatus 127 when reflowed. Other termination techniques can be employed, e.g., gold ball bumping or conductive adhesives, which do not preclude the spirit of this invention. The air bearing surface 215 of slider 129 is shown facing upward.

As shown in FIG. 2, Standoffs 220a and 220b reside on the side of slider 129 opposite air bearing surface 215. Standoffs 220a and 220b provide a needed space between slider 129 and a portion of substrate 225 under slider 129 that is known as the “tongue.” This space provides for the application of an adhesive that bonds slider 129 to substrate 225, according to one embodiment of the present invention. When the slider 129 is bonded to the tongue, standoffs 220a and 220b become physically coupled with slider 129. The physical coupling of slider 129 and standoffs 220a and 220b also provides an electrically conductive path to substrate 225 for bleeding off electrical charge. The electrical charge eventually dissipates into base 113 (FIG. 1). This avoids a build up of static charge on slider 129 that can have a detrimental effect. Standoffs 220a and 220b may also align solder balls 245 with termination pads on slider 129. Standoffs 220a and 220b can be formed from the existing layers of metal in substrate 225, according to one embodiment. In another embodiment, standoffs 220a and 220b may be formed from copper that is plated onto substrate 225 through vias in layers 230 and 235.

Although standoffs 220a and 220b are shown in FIG. 2 as two standoffs having specific shapes, it should be understood that a single standoff of one of any number of sizes and shapes may be used, according to one embodiment. In other embodiments, there may be more than two standoffs of various shapes and dimensions. For example, there may be three standoffs, two being cylindrical columns and one being rectangular. There could be four standoffs, each “L” shaped, etc. Any number and/or configuration of standoffs, comprising a metal, can be formed from a substrate, e.g., substrate 225. In other embodiments, any number and/or configuration of standoffs, comprising a metal, can be plated onto a substrate. Any such standoffs that are configured to be physically coupled to a slider, and further configured to electrically couple the slider to a substrate material, may be used in accordance with embodiments of the present invention.

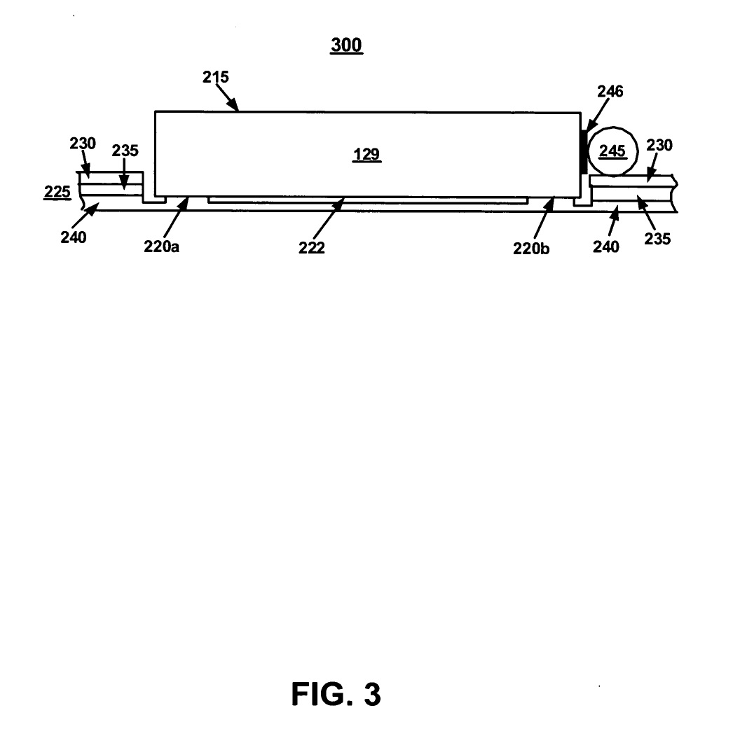

FIG. 3 is a cross-sectional view 300 of a slider 129 and standoffs 220a and 220b, taken along line A-A in FIG. 2, in accordance with one embodiment of the present invention. According to the present embodiment, the substrate material 225 contains a layer 240 of base metal, e.g., stainless steel or copper alloy, and the standoffs 220a and 220b are formed from the base metal 240.

The area disposed between standoffs 220a and 220b comprises a pocket 222 for depositing an epoxy or other type of adhesive for bonding a wireless suspension apparatus (e.g., wireless suspension apparatus 127 of FIG. 2) to slider 129. Bonding wireless suspension 127 to slider 129 establishes physical contact between standoffs 220a and 220b and slider 129 and further establishes electrical coupling between slider 129 and substrate 225. Electrical coupling between slider 129 and substrate 225 allows for dissipation of static charge into base 113 (FIG. 1) by virtue of the electrical conductivity of actuator 121 and pivot assembly 123.

In FIG. 3, it is shown that standoffs 220a and 220b, according to the present embodiment, also function to place slider 129 at an appropriate height for solder ball 245 on the wireless suspension to align with termination pad 246 on slider 129. This allows for forming a solder bond to establish an electrical connection between the transmission lines formed from layer 230 of substrate 225 and slider 129. Other termination techniques can be employed, e.g., gold ball bumping or conductive adhesive, which do not preclude the spirit of this invention.

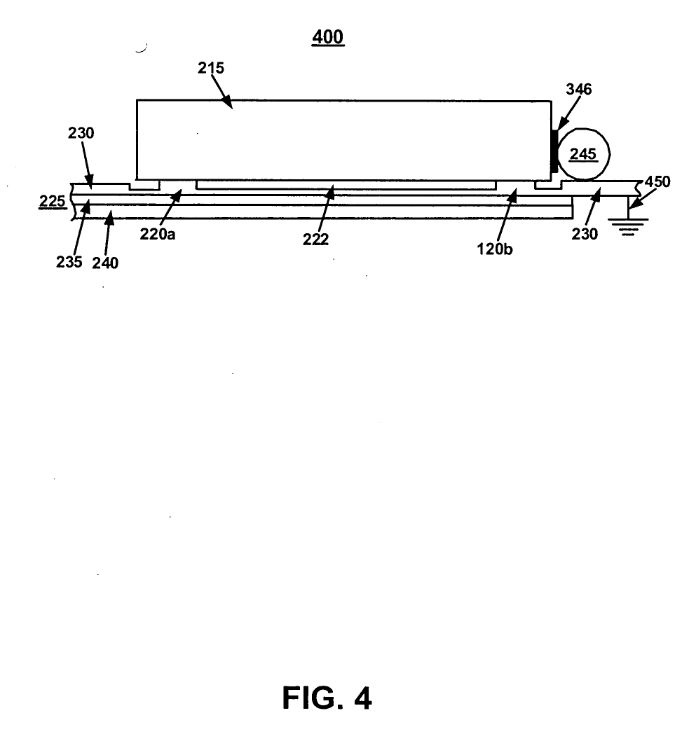

FIG. 4 is a cross-sectional view 400 of a slider 129 and standoffs 220a and 220b, taken along line A-A of FIG. 2, in accordance with another embodiment of the present invention. In the present embodiment, standoffs 220a and 220b are formed by partially etching copper layer 230 of substrate 225.

The area disposed between standoffs 220a and 220b comprises a pocket 222 for depositing an epoxy or other type of adhesive for bonding a wireless suspension apparatus (e.g., wireless suspension apparatus 127 of FIG. 2) to slider 129. Bonding wireless suspension 127 to slider 129 establishes physical contact between standoffs 220a and 220b, formed from copper layer 230, and slider 129. The copper layer 230 is then electrically coupled, e.g., at a point depicted by 450, to establish a conductive path for dissipating static charges that can build up on slider 129. Point 450 is designed to establish a conductive path from slider 129 to base 113 (FIG. 1). Point 450 can connect copper layer 230 to base metal 240 at some location within the wireless suspension apparatus (e.g., wireless suspension apparatus 127 of FIG. 2). In another embodiment, point 450 can connect copper layer 230 directly to flex cable 118 (FIG. 1).

In FIG. 4, it is shown that standoffs 220a and 220b, according to the present embodiment, also function to place slider 129 at an appropriate height for solder ball 245 on the wireless suspension to align with termination pad 346 on slider 129. This allows for forming a solder bond to establish an electrical connection between slider 129 and the transmission lines formed from layer 230 of substrate 225. Other termination techniques can be employed, e.g., gold ball bumping or conductive adhesive, which do not preclude the spirit of the present invention.

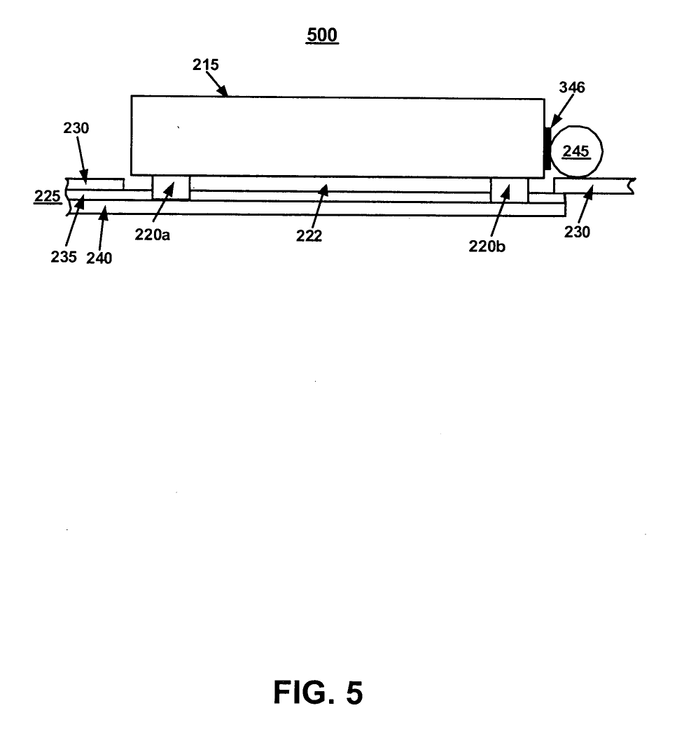

FIG. 5 is a cross-sectional view 500 of a slider 129 and standoffs 220a and 220b, taken along line A-A of FIG. 2, in accordance with yet another embodiment of the present invention. In this embodiment, standoffs 220a and 220b are formed by a plating process during the processing of a wireless suspension apparatus (e.g., wireless suspension apparatus 127 of FIG. 2). According to one embodiment, the plated metal is copper. In other embodiments, the plated metal may be any electrically conductive metal deemed appropriate for forming standoffs 220a and 220b. In one embodiment, the standoffs 220a and 220b are plated onto base metal 240, e.g., stainless steel or copper alloy, into vias formed through polyimide layer 235 of substrate 225.

The area disposed between standoffs 220a and 220b comprises a pocket 222, formed by etching away copper layer 230 of substrate 225 and plating standoffs 220a and 220b through and above polyimide layer 235. Pocket 222 provides a needed space for depositing an epoxy or other type of adhesive to bond a wireless suspension apparatus (e.g., wireless suspension apparatus 127 of FIG. 2) to slider 129. Bonding wireless suspension 127 to slider 129 establishes physical contact between slider 129 and standoffs 220a and 220b, formed from plated metal in vias through and above polyimide layer 235. This physical contact, in turn, establishes electrical coupling between standoffs 220a and 220b and slider 129. This establishes a dissipative path that allows electro-static charges that can build up on slider 129 to bleed off through the electrically conductive standoffs 220a and 220b to the base metal 240. This prevents the detrimental effect that a buildup of electrical charge may have on slider 129, e.g. electro-static discharge damage or electro-static over-stress damage.

FIG. 6 is a flow diagram of a method 600 for electrically coupling a slider to a substrate in a wireless suspension apparatus (e.g., wireless suspension apparatus 127 of FIG. 2), in accordance with one embodiment of the present invention. At step 610, a substrate, e.g., substrate 225 of FIG. 2) is provided. Substrate 225 is, according to one embodiment, a laminate of at least three layers of materials. One layer may be a highly conductive metal, e.g., copper, from which the transmission lines may be formed. An interstitial layer can be an insulating layer, e.g., a polyimide material, separating the electrically conductive layer from another conductive layer, e.g., a base metal such as stainless steel. In another embodiment, the third layer may be another layer of copper. In yet another embodiment, the substrate may begin as a single layer upon which additional layers become deposited.

At step 620 of method 600, at least one standoff (e.g., standoffs 220a and 220b) is formed from a conductive material. The at least one standoff is configured to enable the substrate to be electrically coupled to a slider (e.g., slider 129 of FIG. 2). The at least one standoff provides a needed space between the slider 129 and a portion of the substrate that lies under slider 129 that is known as the “tongue.” This provides a space for the application of an adhesive that bonds slider 129 to the tongue of the substrate, according to one embodiment of the present invention. The bonding of the slider to the tongue provides physical contact between the slider 129 and the at least one standoff. This physical contact provides an electrically conductive path for bleeding off electrical charges to the substrate that can build up on slider 129. This prevents damage that may be inflicted on the slider due to buildup and discharge of electrostatic charges. The at least one standoff also helps to align solder balls with termination pads on slider 129 for electrically bonding the slider to transmission lines.

Standoffs such as 220a and 220b of FIG. 2 can be formed from the existing layers of metal in the substrate, according to one embodiment. In another embodiment, standoffs may be formed from copper or other conductive metal that is plated through vias in layers of the substrate. In all embodiments, standoffs 220a and 220b couple slider 129 with base 113 (FIG. 1) to dissipate electrical charges that can build up on the slider. The conductive path for dissipating electrical charges is through base metal layer 240. In another embodiment, the conductive path is through flex cable 118.

Although standoffs 220a and 220b are shown in FIG. 2 as two standoffs having specific shapes, it should be understood that a single standoff of one of any number of sizes and shapes may, according to one embodiment, be used. In other embodiments there may be more than two standoffs of various shapes and dimensions. Any number and configuration of standoffs, comprising an electrically conductive metal, either formed from a substrate or plated onto a substrate, may be used in accordance with embodiments of the present invention. These standoffs are configured to be coupled to a slider, and further configured to electrically couple the slider to the outer housing or base of the drive.

Thus, the present invention provides, in various embodiments, a method and apparatus for electrically coupling a slider through a wireless suspension and to a drive base. The foregoing descriptions of specific embodiments have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A wireless suspension apparatus comprising:
a substrate material; and
at least one standoff coupled to said substrate material, said at least one standoff configured to be coupled to a slider, wherein said at least one standoff is further configured to electrically couple said slider to said substrate material.

2. The apparatus as described in claim 1, wherein said substrate material comprises stainless steel and wherein said at least one standoff is formed from said base metal.

3. The apparatus as described in claim 1, wherein said substrate material comprises a copper alloy and wherein said at least one standoff is formed from said copper alloy.

4. The apparatus as described in claim 1, wherein said at least one standoff comprises plated metal, said plated metal formed during processing of said wireless suspension apparatus.

5. The apparatus as described in claim 4, wherein said plated metal is copper.

6. The apparatus as described in claim 1, wherein said at least one standoff comprises a plurality of standoffs.

7. The apparatus as described in claim 6 wherein an area disposed between said plurality of standoffs comprises an epoxy pocket for bonding said wireless suspension to said slider.

8. The apparatus as described in claim 7 wherein said bonding said wireless suspension to said slider establishes contact between said plurality of standoffs and said slider for establishing said electrical coupling to said slider.

9. A method for providing electrical conductivity between a wireless suspension apparatus and a slider, said method comprising:
providing a substrate material; and
providing at least one standoff, said at least one standoff configured to electrically couple said slider to said substrate material.

10. The method as recited in claim 9, further comprising providing a base metal in said substrate and wherein said at least one standoff is formed from said base metal.

11. The method as recited in claim 9, further comprising providing copper in said substrate and wherein said at least one standoff is formed from said copper.

12. The method as recited in claim 9, further comprising plating a metal on said substrate, wherein said plating metal is performed during processing of said wireless suspension apparatus.

13. The method as recited in claim 12, wherein said plating metal further comprises plating copper.

14. The method as recited in claim 9, further comprising providing a plurality of standoffs.

15. The method as recited in claim 14 further comprising bonding said wireless suspension to said slider in an area disposed between said plurality of standoffs.

16. The method as recited in claim 15, further comprising providing contact between said plurality of standoffs and said slider for establishing said electrical coupling for bleeding off static charge from said slider.

17. A hard disk drive comprising:
a housing;
a disk pack mounted to the housing and having a plurality of disks that are rotatable relative to the housing, the disk pack defining an axis of rotation and a radial direction relative to the axis;
an actuator mounted to the housing and being movable relative to the disk pack, the actuator having a plurality of heads for reading data from and writing data to the disks; and
a wireless suspension apparatus coupled to said actuator, said wireless suspension apparatus comprising:
a substrate material; and
at least one standoff coupled to said substrate material, said at least one standoff configured to be coupled to a slider, wherein said at least one standoff is further configured to electrically couple said slider to said housing.

18. The hard disk drive as recited in claim 17, wherein said substrate comprises stainless steel and wherein said at least one standoff is formed from said stainless steel.

19. The hard disk drive as recited in claim 18, wherein said substrate comprises a copperalloy and wherein said at least one standoff is formed from said copper alloy.

20. The hard disk drive as recited in claim 18, wherein said at least one standoff comprises plated metal, said plated metal added during processing of said wireless suspension apparatus.
